(19) United States
(12) Patent Application Publication
(10) Pub. No.: US 2004/0238036 A1
(43) Pub. Date: Dec. 2, 2004

(54) Spring and valve seal seating tool

(76) Inventor: Robert Byers, Nicholasville, KY (US)

Correspondence Address: KING & SCHICKLI, PLLC, 247 NORTH BROADWAY, LEXINGTON, KY, 40507, US

(21) Appl. No.: 10/847,110

(22) Filed: May 17, 2004

Related U.S. Application Data
(60) Provisional application No. 60/474,838, filed on May 30, 2003.
(60) Provisional application No. 60/502,061, filed on Sep. 11, 2003.

(51) Int. Cl. F16K 51/00

(52) U.S. Cl. 137/315.41

(57) ABSTRACT

A tool is provided for removing and installing valve seals and valve seal springs in a water faucet. The tool includes a handle having a blind bore, a probe having a proximal end received in the blind bore and a distal end projecting from the handle and a sleeve received over at least a portion of the probe.

This application claims the benefit of U.S. Provisional Patent Application Serial No. 60/474,838 filed on May 30, 2003 and U.S. Provisional Patent Application Serial No. 60/502,061 filed on Sep. 11, 2003.

### TECHNICAL FIELD

The present invention relates generally to a tool for both removing and installing valve seals and valve seal springs such as may be found in a water faucet.

### BACKGROUND OF THE INVENTION

Single handle faucets for controlling the flow of both hot and cold water are in common use today. Typically, such faucets include a handle or knob that is movable in two different directions to adjust both the volume or water flow rate and the mix of hot and cold water in order to achieve a desired water temperature.

One of the more common single handle faucet designs incorporates a ball valve. An example of such a design is found in U.S. Pat. No. 5,813,435 to Knapp, owned by Masco Corporation of Taylor, Mich. As illustrated in this patent the ball valve mechanism incorporates tubular elastomeric sealing elements, also known as seats or seals that are biased by springs against a ball valve element housed in a cartridge. Over time the elastomeric seals may lose their effectiveness and need to be replaced. In many faucet designs the seals are located a significant distance down in the faucet housing or shell and are difficult to reach. The present invention relates to a tool that is particularly useful when removing old ineffective seals and installing new seals.

### SUMMARY OF THE INVENTION

In accordance with the purposes of the present invention as described herein, a tool is provided comprising a handle including a blind bore, a probe having a proximal end received in the blind bore and a distal end projecting from the handle and a sleeve received over at least a portion of the probe.

The distal end of the probe includes a groove and a rounded or beveled tip with the groove being positioned adjacent the tip. In one possible embodiment the tip has a length of about 1.5 to about 4.0 mm and the groove has a width of about 1.0 to about 4.0 mm. As illustrated in FIG. 2, the tip may be beveled at an angle of between about 45 degrees to about 65 degrees (typically about 55 degrees) relative to the sidewall of the probe. In addition, the probe may be magnetized.

A compression spring is received in the blind bore of the handle. A portion of the compression spring is concentrically received around a portion of the proximal end of the probe. In addition, the probe includes a rib having a first shoulder engaging an end of the compression spring. A second shoulder of the rib may engage the first end of the sleeve. Further, the sleeve may be secured to the handle.

In accordance with yet another aspect of the present invention the tool may be provided for removing or installing a seal and spring assembly such as commonly associated with certain designs of water faucets. Further, the tool may be alternatively described as comprising a handle, a probe carried on the handle and a sleeve received over a portion of the probe. Additionally, the probe is selectively displaceable between a seal and spring holding position wherein an end of the probe is exposed from the sleeve and a seal and spring seating position wherein the seal and spring arrangement are released from the probe and seated in a desired position such as in a faucet assembly.

In the following description, there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of the specification, illustrates several aspects of the present invention, and together with the description serves to explain certain principles of the invention. In the drawing:

FIG. 1 is an exploded perspective view of the tool of the present invention;

FIG. 2 is a detailed side elevational view showing the probe of the tool in the seal and spring holding position (see full line) and the seal and spring seating position (see phantom line);

FIG. 2a is a schematic detail of the tip and groove of the probe;

FIG. 3 is a detailed side elevational view showing a seal and spring arrangement positioned on the end of the probe;

FIG. 4 is a detailed side elevational view illustrating how the probe is utilized to seat a seal and spring arrangement in a faucet assembly;

FIG. 5a is a side elevational view of an alternative embodiment of the present invention; and

FIG. 5b is a detailed side elevational view of the probe utilized in the tool illustrated in FIG. 5a.

Reference will now be made in detail to the present preferred embodiment of the invention, an example of which is illustrated in the accompanying drawing.

### DETAILED DESCRIPTION OF THE INVENTION

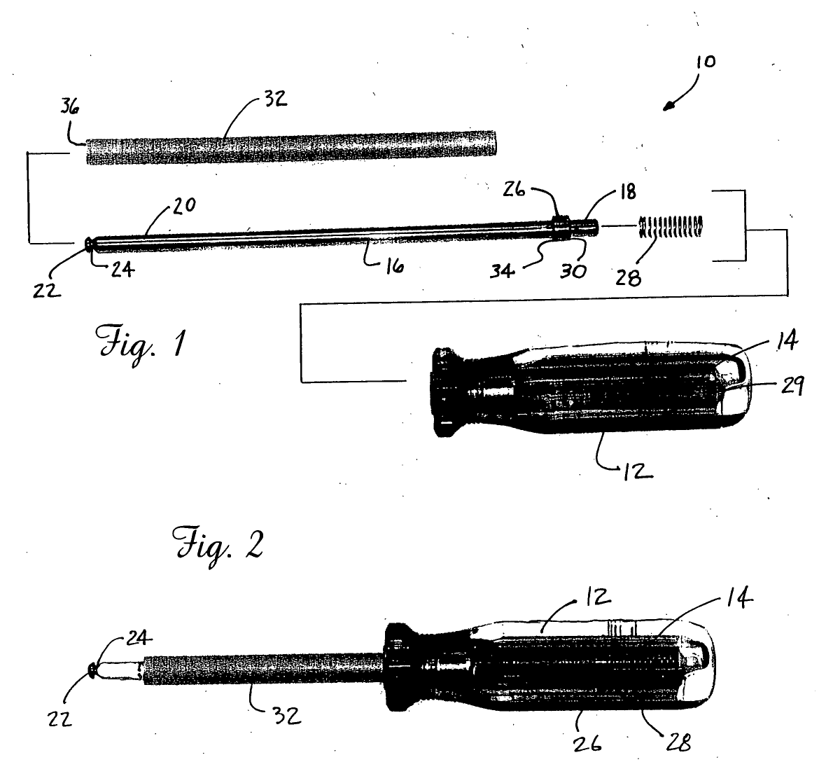

As best illustrated in FIG. 1, the tool 10 of the present invention includes a handle 12 having a blind bore 14. The tool 10 also includes a probe 16 having a proximal end 18 that is received in the blind bore 14 of 5 the handle 12 and a distal end 20. The distal end 20 includes a rounded or beveled tip 22 and a groove 24 adjacent the tip. The tip 22 has a length of about 1.5 to about 4.0 mm. The groove 24 has a width of about 1.0 to about 4.0 mm and the probe has an overall diameter of about 6.0 to about 6.4 and more typically 6.15 to 6.25 mm.

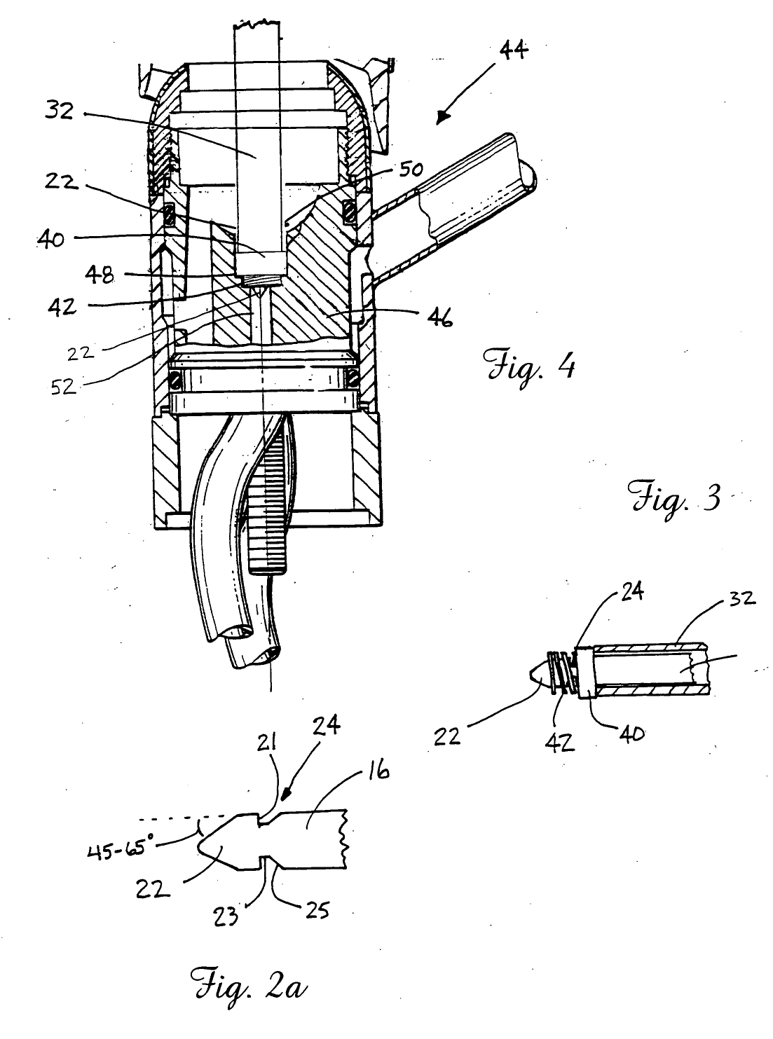

More specifically, the tip 22 preferably includes a beveled angle of between 45 degrees to about 65 degrees and typically about 55 degrees with respect to the sidewall of the probe 16 (see FIG. 2a). In a ball type valve, the cavity for receiving the spring and seal sits at an angle of about 30 degrees to 35 degrees from perpendicular. In contrast, the water inlet tube into the cavity is perpendicular to the valve. The tip 22 may be used to contact the inner wall of the water inlet tube and the bevel insures that the spring and seal are properly aligned for seating in the cavity.

The groove 24 is comprised of three surfaces (see FIG. 2a). The forward surface 21 is cut square with the tip 22 and the sidewall of the probe 16. The bottom surface 23 is flat. The rear surface 25 of the groove 24 is beveled at an angle of about 45 degrees. The depth of the groove is approximately 1.5 mm.

As further illustrated, the probe 16 includes a rib 26 adjacent the proximal end 18 thereof. A biasing element in the form of a compression spring 28 is concentrically received around a portion of the proximal end 18 of the probe 12 while being held in the blind bore 14. The spring 28 is compressed between the end wall 129 of the blind bore 14 and a first shoulder 30 of the rib 26.

A sleeve 32 is concentrically received about the probe 16. More specifically, the sleeve 32 has a diameter of approximately 9.40 mm to about 11.5 mm. The sleeve 32 includes a first end that is received in the blind bore 14. The sleeve 32 is secured to the handle 12 by means of, for example, an adhesive, friction fit or threaded connection. It, of course, should be appreciated that the sleeve 32 need not be secured in the handle 12 if desired for some reason.

As should be appreciated, the probe 16 is biased by the spring 28 into a seal and spring holding position illustrated in full line in FIG. 2 (note length of exposed probe L₁) and in FIG. 3. In this position the second shoulder 34 of the rib 26 engages the end of the sleeve 32. The probe 16 is, however, also selectively displaceable to a seal and spring seating position illustrated in phantom line in FIG. 2 (note length of exposed probe L₂) and in FIG. 4. In this position, the probe 16 is pushed down into the bore 14 of the handle 12 against the biasing of the spring 28 until the second or exposed end 36 of the sleeve 32 nearly or completely covers the tip 22 of the probe 16 so that a seal 40 and spring 42 slides from the tip of the probe and may be seated in a faucet assembly 44 as illustrated in FIG. 4.

The tool 10 of the present invention may, advantageously, be utilized to both remove and install a seal 40 and a spring 42 from a cavity 48 in a valve housing 46 of a faucet assembly 44. More specifically, the seal 40 includes a central aperture 50. The tip 22 of the tool 10 is inserted in the valve housing 46 and is guided into the aperture 50 in the seal 40. The rounded or beveled tip 22 helps guide the probe 16 into the aperture 50 of the seal 40. The tool 10 is manipulated and tilted slightly so that the groove 24 engages the spring 42 in the seal 40. More specifically, the square cut of the forward surface 21 of the groove 24 allows the tool 10 to grab the old spring 42 to remove the seal 40 and spring as a unit. The width of the groove 24 accommodates the spring strand. The beveled rear surface 25 aids in seating the strand of the spring 42 deep in the groove 24 where it may be reliably grabbed or engaged with the forward surface 21 for efficient removal. The tool is then withdrawn from the faucet assembly 44 with the seal 40 and spring 42 connected to the tip 22. In one embodiment, the probe 16 is magnetized to better ensure that the spring 42 is positively held to the tip 22 of the probe 16 during the removal and seating operations.

The old seal 40 is then removed from the probe 16 and a new seal 40 is positioned on the spring 42. Of course, if desired, a new spring 42 may also be utilized to replace the old spring.

The tool 10 is then utilized to install the new seal 40 and spring 42 in the cavity 48 of the valve housing 46. More specifically, the seal 40 and spring 42 are held on the end of the probe 16 by the groove 24 and the magnetic attraction between the probe 16 and the spring 42. The tool 10 is manipulated so that the rounded or beveled tip is received in the cavity 48. The tip 22 actually enters the water inlet 52 and the beveling insures centering thereof in the cavity 48. This, in turn, insures that the seal 40 and spring 42 are properly seated in the cavity 48. The operator then presses the handle 12 toward the faucet assembly 44 so that the probe 16 is pushed into the blind bore 14 against the spring 28. As this occurs the exposed end 36 of the sleeve 32 functions to push the seal 40 and spring 42 off the tip 22 of the probe 16 so that they are fully seated in the cavity 48. The tool 10 is then removed and the faucet is completely assembled in a manner well known in the art.

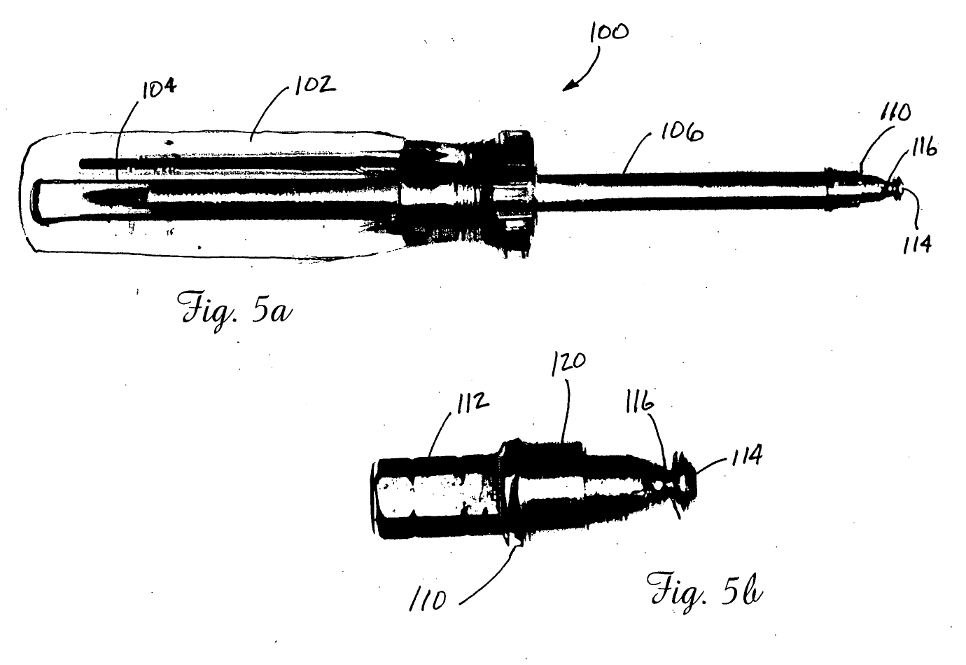

An alternative embodiment of the present invention is illustrated in FIGS. 5a and 5b. FIG. 5a illustrates a tool 100 having a handle 102 including a bore 104 that receives a barrel 106. The barrel 106 includes a lumen that is hexagonal in cross section. A probe 110 is received in one end of the barrel 106. The probe 110 includes a body having a hexagonal mounting end 112 sized and shaped to be snugly received and held in the lumen of the barrel 106. Additionally, the probe 110 includes a distal end including a rounded or beveled tip 114 and a groove 116 adjacent the tip. The tip 114 has a length of about 1.5 to about 4.0 mm. The groove 116 has a width of about 1.0 to about 4.0 mm and the probe 110 has an overall diameter of about 6.0 to about 6.4 and more typically 6.15 to 6.25 mm. The length from the end of the tip 114 to the ferrol 120 is from about 6.0 to about 18.0 mm and typically about 12.7 mm. The tip 114 and groove 116 may in all other aspects be identical to the tip 22 and groove 24 previously described.

Advantageously, the mounting end 112 of the probe 110 is of a size, shape and length to allow the probe to be secured in the end of a standard flip screw driver handle such as illustrated. The flip screw driver tool 100 could, for example, include a tool insert 120 in the other end of the barrel comprising a #2 Phillips drive on one end and a ⅛ inch Allen drive on the other end. The ⅛ inch Allen drive may be used to remove the handle on a single handle kitchen faucet while the Phillips drive may be used on most other faucet handles.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, the tool 10 illustrated in FIG. 1 could be made without any moving parts. Thus, the probe 116 would simply be rigidly held in the handle 12.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

I claim:

1. A tool, comprising:
a handle including a blind bore;
a probe having a proximal end received in said blind bore and a distal end projecting from said handle; and
a sleeve received over at least a portion of said probe.

2. The tool of claim 1, wherein said distal end of said probe includes a groove.

3. The tool of claim 2, wherein said distal end includes a rounded or beveled tip.

4. The tool of claim 3, wherein said tip is beveled at an angle of about 45 degrees to about 65 degrees from a sidewall of said probe.

5. The tool of claim 4, wherein said groove is adjacent said beveled tip.

6. The tool of claim 5, further including a compression spring received in said blind bore of said handle.

7. The tool of claim 6, wherein a portion of said compression spring is concentrically received around a portion of said proximal end of said probe.

8. The tool of claim 7, wherein said probe includes a rib having a first shoulder engaging an end of said compression spring.

9. The tool of claim 8, wherein a first end of said sleeve is secured to said handle.

10. The tool of claim 9, wherein said rib has a second shoulder engaging said first end of said sleeve.

11. The tool of claim 10, wherein said tip has a length of about 1.5 to about 4.0 mm and said groove has a width of about 1.0 to about 4.0 mm.

12. The tool of claim 11, wherein said probe is magnetized.

13. The tool of claim 1, wherein said distal end includes a rounded or beveled tip.

14. The tool of claim 13, wherein said tip is beveled at an angle of about 45 degrees to about 65 degrees from a sidewall of said probe.

15. The tool of claim 1, further including a compression spring received in said blind bore of said handle.

16. The tool of claim 15, wherein a portion of said compression spring is concentrically received around a portion of said proximal end of said probe.

17. The tool of claim 16, wherein said probe includes a rib having a first shoulder engaging an end of said compression spring.

18. The tool of claim 17, wherein a first end of said sleeve is secured to said handle.

19. The tool of claim 18, wherein said rib has a second shoulder engaging said first end of said sleeve.

20. The tool of claim 1, where said probe is magnetized.

21. A tool for removing or installing a seal and spring arrangement, comprising:
a handle;
a probe carried on said handle; and
a sleeve received over a portion of said probe;
said probe being selectively displaceable between a seal and spring holding position wherein a first length L₁ of said probe is exposed from said sleeve and a seal and spring seating position wherein a second length L₂ of said probe is exposed from said sleeve where L₂<L₁ and the seal and spring arrangement are released from said probe and seated in a desired position.

22. The tool of claim 21, wherein said end of said probe includes a groove.

23. The tool of claim 22, wherein said end includes a rounded tip.

24. The tool of claim 23, wherein said groove is adjacent said rounded or beveled tip.

25. The tool of claim 24, wherein said tip is beveled at an angle of about 45 degrees to about 65 degrees from a sidewall of said probe.

26. The tool of claim 24, further including a compression spring received in said handle.

27. The tool of claim 24, further including a biasing element held in said handle and biasing said probe into said seal and spring holding position.

28. The tool of claim 27, wherein said probe includes a rib having a first shoulder engaging an end of said biasing element.

29. The tool of claim 28, wherein a first end of said sleeve is secured to said handle.

30. The tool of claim 29, wherein said rib has a second shoulder engaging said first end of said sleeve.

31. The tool of claim 30, wherein said tip has a length of about 1.5 to about 4.0 mm and said groove has a width of about 1.0 to about 4.0 mm.

32. The tool of claim 31, wherein said probe is magnetized.

33. A faucet repair kit, comprising:
a tool including a handle having a blind bore, a probe having a proximal end received in said blind bore and a distal end projecting from said handle and a sleeve received over at least a portion of said probe;
at least one seal; and
at least one spring.

34. A faucet repair kit, comprising:
at least one seal;
at least one spring; and
a tool including a handle, a probe carried on said handle, a sleeve received over a portion of said probe, said probe being selectively displaceable between a seal and spring holding position wherein a first length L₁ of said probe is exposed from said sleeve and a seal and spring seating position wherein a second length L₂ of said probe is exposed from said sleeve where L₂<L₁ and the seal and spring arrangement are released from said probe and seated in a desired position.

35. A tool, comprising:
a handle; and
a probe connected to said handle, said probe including a groove and a rounded or beveled tip.

36. The tool of claim 35, wherein said tip is beveled at an angle of about 45 degrees to about 65 degrees from a sidewall of said probe.

37. The tool of claim 36, wherein said groove is adjacent said beveled tip.

38. The tool of claim 37, wherein said tip has a length of about 1.5 to about 4.0 mm and said groove has a width of about 1.0 to about 4.0 mm.

39. The tool of claim 38, wherein said probe is magnetized.

40. A probe, comprising:
a body including a mounting end, a rounded or beveled tip and a groove adjacent said tip.

41. The probe of claim 40 wherein said mounting end is hexagonal in cross section.

42. The probe of claim 40, wherein said tip has a length of between about 1.5 and about 4.0 mm.

43. The probe of claim 42, wherein said groove has a width of about 1.0 to about 4.0 mm.

44. The probe of claim 43, wherein said probe includes a ferrol between said groove and said mounting end, said ferrol being spaced from about 6.0 to about 18.0 mm from said tip.
